(19) United States
(12) Patent Application Publication
(10) Pub. No.: US 2020/0018548 A1
(43) Pub. Date: Jan. 16, 2020

(54) SPRAY NOZZLE FOR SPRAYING AN ARTICLE TO BE DRIED, SPRAY DRYER, AND METHOD FOR MONITORING AND/OR CONTROLLING AND/OR REGULATING A TEMPERATURE DURING THE SPRAYING PROCESS

(71) Applicant: Lübb Anlagen - Und Umwelttechnik Gmbh, Bad Langensalza (DE)

(72) Inventor: Matthias Lübbers, Bad Langensalza (DE)

(73) Assignee: Lübb Anlagen - Und Umwelttechnik Gmbh, Bad Langensalza (DE)

(21) Appl. No.: 16/485,036

(22) PCT Filed: Jan. 29, 2018
(86) PCT No.: PCT/DE2018/200003

§ 371 Date: Oct. 3, 2019

(30) Foreign Application Priority Data
Feb. 10, 2017 (DE) 10 2017 102 716.5

(51) Int. Cl. F26B 3/12; B05B 7/14; B05B 12/00; F26B 21/10; F26B 23/04; F26B 21/00; A23C 9/18

(52) U.S. Cl. CPC F26B 3/12; B05B 7/14; B05B 12/004; A23C 9/18; F26B 21/10; F26B 23/04; F26B 21/004; B05B 12/008

(57) ABSTRACT

A spray nozzle is used for spraying a product to be dried, wherein the spray nozzle has a groove on an outer wall, and a measurement sensor for measuring a measured value is disposed in the groove, wherein an autarkic energy supply is associated with the measurement sensor. The autarkic energy supply, in particular by means of a piezo-element, is disposed in the groove, so that the measurement sensor can be operated without an external cable-based energy supply. In addition, a spray dryer is used for drying a product to be dried and to a method for monitoring and/or controlling and/or regulating a temperature when drying a product to be dried.

The invention relates to a spray nozzle for spraying a product to be dried, wherein the spray nozzle has a groove on an outer wall. The invention further relates to a spray dryer for drying a product to be dried and to a method for monitoring and/or controlling and/or regulating a temperature during spraying of a product to be dried.

Spray drying requires a homogeneous and continuous spraying of a product to be dried by means of a spray nozzle. Otherwise, an inhomogeneous drying process and a deposition of components of the product to be dried on the spray nozzle or on the inner walls of a drying chamber will occur. In addition to a degradation of the quality of the dried product, undesired potential flame sources (so-called hot spots) will appear at the place of the deposition of the product to be dried or its components with an increased risk of fire and explosion. This hazard exists particularly when organic components are contained in the product to be dried and/or when the spraying process is interrupted.

Usually, in order to monitor the spray drying process, the temperature at the inlet and at the outlet of the drying chamber is measured. However, this does not allow for detecting local potential hot spots with an increased temperature.

The document WO 2011/063808 discloses a method for monitoring a spray dryer, in which one or several infrared cameras allow capturing an image field in the drying chamber of the spray dryer through lances and a temperature is measured in an area specified thereby.

The disadvantage of this method is that the infrared camera must be protected by an inspection glass, on which spray droplets and product particles can also be deposited. In addition, due to the construction of the spray dryer, a necessary introduction of the lance into the drying chamber and orientation of the infrared camera toward a spray nozzle can be difficult. Due to the limited line of sight, the infrared camera may not detect a temperature increase on the observed side of the spray nozzle, but the drying product may settle on the opposite non-observed side and thus form potential flame sources. Generally, there is a risk that the infrared camera may be oriented toward a field of view, in which there is no existing flame source.

The problem underlying the invention is to improve upon the prior art.

The problem is solved by a spray nozzle for spraying a product to be dried, wherein the spray nozzle comprises a groove on an outer wall and a measurement sensor for measuring a measured value is disposed in the groove, wherein an autarkic energy supply is associated with the measurement sensor and/or the autarkic energy supply, in particular by means of a piezo-element, is disposed in the groove, so that the measurement sensor can be operated without an external cable-based energy supply.

This makes it possible to measure the actually occurring temperature directly at the spray nozzle and to detect a relevant measured value, such as an increased temperature, and thus the formation of incrustations and potential flame sources at an early stage.

In this regard, it has surprisingly been found that precisely the arrangement of the measurement sensor in the groove on the outer wall of the spray nozzle is a suitable measuring site for early determination of a change in a measured value, in particular a temperature increase.

Because of the autarkic energy supply of the measurement sensor in the groove, there is no need for leading an external energy supply cable to the measurement sensor that could otherwise interfere with the operation of the spray nozzle, for example if the cable gets tangled up in the case of a rotating spray nozzle.

An essential idea of the invention is that by arranging the measurement sensor directly in the groove on the outer wall of the spray nozzle, the acquisition of a measured value takes place directly at the location, in which spraying occurs and in which deposits appear, the latter, in particular, causing a pressure and/or temperature change.

Surprisingly, it has proven to be particularly advantageous that a measurement sensor with a piezo-element is disposed in the groove and that the piezo-element is clamped in an extension dimension of the groove. Since the piezo-element and/or the measurement sensor is/are securely clamped between the opposing inner walls of the groove, the directed mechanical deformation of the piezo-element can be directly used for an internal voltage supply of the measurement sensor.

It is particularly advantageous that existing drying systems can be retrofitted at very low cost with the described spray nozzle.

The following terms must be explained:

A “spray nozzle” (also called “atomizer nozzle”) is in particular a nozzle for spraying a liquid product to be dried in small droplets and for simultaneously dispersing the fine droplets in a drying gas. The spray nozzle serves in particular to create a very large reactive liquid surface by spraying. A spray nozzle is in particular a rotary atomizer, a one-component nozzle, a two-component nozzle, a three-component nozzle, a four-component nozzle and/or an ultrasonic nozzle. In addition, the term also includes a rotary atomizer (also referred to as a rotation atomizer).

The spray nozzle comprises in particular a groove on an outer wall, in and/or at which a measurement sensor is disposed for measuring the temperature, the pressure, and/or another measured value. The spray nozzle has in particular a nozzle opening of 0.1 mm to 5 mm, preferably of 0.5 mm to 3 mm. The spray nozzle allows in particular implementing a volume flow of up to 750 L/h of a liquid.

“Spraying” must be understood in particular as a dispersion of a liquid in fine droplets in the form of an aerosol (mist) in a gas.

“product to be dried” is in particular a liquid, such as solution, a suspension or an emulsion, which is sprayed in a drying gas for drying and forming dry particles (individual particles, agglomerates and/or granulates).

An “outer wall” of the spray nozzle is a wall, which separates an outer chamber, in particular the drying chamber, from the inner chamber of the spray nozzle. The outer wall is in particular the wall that is in contact with a drying gas and/or the drying chamber.

A “groove” is in particular an elongated recess that is disposed in an outer wall of the spray nozzle. The groove is in particular a through groove or a stopped groove. The groove has in particular a rectangular, trapezoidal, round, outwardly slanted and/or swallow-tailed cross-section. A measurement sensor and/or an antenna is or are disposed in the groove. The groove can be formed for example transversely to the longitudinal direction of the spray nozzle in a radially circumferential manner in the outer casing of the spray nozzle. The groove can also be disposed as a stopped groove at that downward oriented outer wall of the spray nozzle at which the nozzle opening is also located. Here, a recess should also be understood as a groove.

A “measurement sensor” is in particular a technical component, which qualitatively or quantitatively acquires certain physical or chemical properties and/or a material composition of its environment. The heat quantity, the temperature, the humidity, the pressure, the sound field parameters, the pH value, the ionic strength, the electrochemical potential and/or another property in particular are determined by means of a measurement sensor. The acquired qualitative or quantitative measured value is transformed in particular by the measurement sensor into a processable electrical measurement signal. A measurement sensor is a passive sensor, in particular with regard to its energy consumption, since it does not require auxiliary electrical energy for generating an electrical measurement signal.

In particular, the measurement sensor comprises an electricity-generating piezo-element. A measurement sensor is in particular a SAW-sensor (Surface Acoustic Wave; for example a SAW Sensor Element produced by SAW COMPONENTS Dresden GmbH), which utilizes a surface acoustic wave that spreads planarly on a surface in only two dimensions of the SAW-sensor. A SAW-sensor consists in particular in a piezo-electric substrate onto which metallic structures (transponder and reflector) are applied. In a SAW-sensor an incoming signal in particular is sent back as an echo by way of the same antenna, after the signal has run through the surface acoustic wave structure and has been reflected by two or more structures. In so doing, the SAW-sensor utilizes in particular the dependence of the surface wave velocity on the mechanical tension and/or the temperature. The SAW-sensor operates consistently in particular in a wide temperature range of −55° C. to above 400° C.

A “measured value” is in particular that physical or chemical value that is subjected to a measurement. Thus, a measured value is, was or will be in particular the target of a measurement.

A “measurement signal” is in particular a processable electrical signal, which is or has been converted from a qualitative or quantitative measured value. A measurement signal is in particular also a physical value one or several parameters of which carry information about one or several variable measured values. A measurement signal is in particular also an electrical value, such as current intensity or voltage, for holding and transporting information. In this respect, the parameter of the measurement signal is used in particular directly, or the information is impressed by means of modulation onto a so-called carrier signal. The transmission of the measurement signal takes place in particular by means of electromagnetic waves as carriers for a piece of information (radio signal) or by optical transmission.

An “autarkic energy supply” is in particular a supply of the measurement sensor with the necessary energy, which is generated exclusively by the measurement sensor itself, and/or an external receiver associated with the measurement sensor. The autarkic energy supply in particular does not require providing the required energy by means of a battery and/or a current-carrying cable. In particular, an autarkic energy supply can continuously provide energy and thus ensure a very long service life of the measurement sensor and the spray nozzle of more than 10,000 h, preferably more than 50,000 h.

A “piezo-element” is in particular a component utilizing the piezo-effect, in order to generate an electrical current when a mechanical force is applied. In particular in case of a directed deformation of the piezo-element, a modification of the electrical polarization occurs and an electric voltage thus appears at the piezo-element. Regarding the directed deformation, the applied pressure acts more specifically only from two opposite sides onto the piezo-element. Thus, a directed deformation can be implemented in particular by clamping the piezo-element between two opposite lateral walls of a groove. A piezo-element comprises in particular a piezo-crystal or a piezoelectric ceramic. Electrodes in particular are applied onto the piezo-element, so that the electrical field generated by a mechanical force caused by the clamping produces a voltage at the electrodes. In particular, a piezo-element can also be a piezo-stack, which consists of several thin piezo-elements sandwiching electrodes. In particular, a piezo-element can also be used as a current or voltage source.

“Without an external cable-based energy supply” means that no electrical power fed through an electrical conductor is used as a power supply, which is provided by an external energy source, for example a battery and/or a power network. An external cable-based power supply means in particular that the energy generation takes place externally outside of the measurement sensor and/or its associated components, such as an external receiver, for example.

In another embodiment of the spray nozzle, the measurement sensor comprises an emitter and an antenna for a wireless transmission of a measurement signal.

That way the readout and/or processing of the measurement signal can take place outside the spray nozzle and/or a spray dryer, so that the spray nozzle can be designed with a smaller size. In addition, only the measurement sensor, the emitter and the antenna are exposed to the environmental conditions during spraying and only they need to be designed so as to be suitably resistant.

In addition to the wireless autarkic energy supply of the measurement sensor, it is particularly advantageous that the transmission of the measurement signal also takes place wirelessly, so that the operation of the spray nozzle is not hindered by a cable routing.

An “emitter” is in particular a device that converts a measurement signal, other signals and/or information into electromagnetic waves and emits them in that form. The emitter consists in particular of an oscillator with a subordinated amplifier, wherein a transmitting antenna is associated with the emitter. In particular, an emitter can also be a transponder that, as a radiocommunication unit, receives incoming signals and automatically responds to them. A transponder reads in particular measurement data and/or other data from an associated memory and transfers them so that an identity and/or other stored information is transmitted. A transponder can be in particular a passive transponder, which takes its operating voltage from an electromagnetic field of an external receiver, or an active transponder, which uses the voltage supply of the measurement sensor to supply its processor and for the transmission of data. A transponder can more specifically be an RFID-transponder and/or an inductive transponder. An emitter and/or a transponder can more specifically have its own antenna or a separate antenna can be assigned to the emitter and/or the transponder.

An “antenna” is in particular a technical device for emitting or receiving electromagnetic waves and/or signals. An antenna is used in particular for wireless communication. An antenna generates in particular electrical and/or magnetic fields.

A “wireless transmission” is in particular the transmission of all sorts of signals by means of modulated electromagnetic waves. During “wireless transmission”, the transmission takes place even without the use of a transmission cable.

In order to minimize the influence of environmental conditions and/or damage, the measurement sensor and/or the antenna is or are embedded in the groove by means of a casting material.

In addition, the measurement sensor and/or the antenna are fixed in position in its/their arrangement inside their groove, so that their position and/or the position of the piezo-element is not changed by forces acting from the outside, such as e.g. the rotation of the spray nozzle.

A “casting material” serves to embed the measurement sensor, its piezo-element, its autarkic energy supply, its emitter and/or its antenna in the groove, so that it is enveloped, protected against the intrusion of humidity, particles and/or against other environmental conditions, and fixed in the groove and so that their mechanical stability is improved. A casting material is in particular quartz glass and/or a food-safe synthetic material.

In another embodiment an external receiver is associated with the spray nozzle for readout, evaluation and/or monitoring of the measurement signal.

Thus, the further processing and evaluation of the measurement signal can be provided at a distance from the spray nozzle. As a result, the components of the external receiver do not have to be heat-resistant and/or resistant to the environmental conditions of the spray nozzle and/or of a spray dryer. It is particularly advantageous that, as a result of its external arrangement, the receiver can also be part of a control and regulation system of an entire spray drying facility.

A “receiver” is in particular a unit or a specific module that eliminates interferences in, amplifies and/or demodulates an antenna signal. A receiver receives in particular the electromagnetic signals of a spray nozzle and converts them by means of electronic circuits into digital, audible and/or visible signals and/or commands for radio remote control. An external receiver can in particular detect a received electromagnetic signal, and extract, signal and/or display variable states, data and/or information therefrom. In addition to receiving electromagnetic signals, an external receiver can also send signals. An external receiver can also more specifically be an RFID-reader module, which can more specifically also send targeted signals, such as e.g. an activation signal, to a transponder. In addition to a state of the spray nozzle, the external receiver can in particular also readout and/or display a series identification number of the spray nozzle and/or its status.

In order to ensure an optimal wireless transmission of a measurement signal, the emitter has a frequency in the range of 9 kHz to 3,000 GHz, preferably of 400 MHz to 2.5 GHz.

Thus, a broad frequency range extending from a long wave to an ultrahigh frequency can be utilized. Thus, a suitable frequency can be chosen according to the transmission conditions and the desired range between the spray nozzle and the external receiver. For example, when using decimeter waves or microwaves, a range of 3 m to 10 m can be achieved.

It is particularly advantageous if, when using several spray nozzles in a spray dryer, each emitter of the respective spray nozzle uses a different frequency. That way, the unambiguousness of the signals transmitted and readout by the external receiver is increased.

In another embodiment of the spray nozzle, an information for identifying the spray nozzle can be sent by means of the emitter.

Thus, when using several spray nozzles, the respective measurement signal can be unambiguously associated with the associated spray nozzle and the latter can be unambiguously identified.

To this end, the identification can be carried out by transmitting a serial identification number, a specific identification signal and/or codes to the external receiver.

It is particularly advantageous that, in the case of a SAW-sensor, the identification can be carried out by way of its resonance frequency.

In order to monitor the optimal operation of a spray nozzle and/or of the drying process of a product to be dried, the measurement sensor is a temperature sensor and/or a pressure sensor.

Thus, a malfunction and/or a need for maintenance of a spray nozzle can be detected at an early stage by way of a loss of pressure and/or an increase of the temperature.

It is particularly advantageous that deposits and potential flame sources can be detected directly at the spray nozzle at an early stage and that the risk of fire and explosion can thus be reduced.

A “temperature sensor” is in particular an electrical or electronic component that provides an electrical signal as a measure for the temperature. By means of the temperature sensor, the temperature is measurable in particular in a range of −55° C. to 1,200° C., preferably of −40° C. to 350° C. A temperature sensor is in particular a SAW-sensor.

A “pressure sensor” is in particular an electrical or electronic component that provides an electrical signal as a measure for the pressure. A pressure sensor is in particular a SAW-sensor.

In another embodiment the spray nozzle is connected with a supply line by means of a detachable connection.

The detachable connection provides an easy replaceability and retrofitting capability of the spray nozzle. In particular, only the front part of the spray nozzle needs to be replaced with the measurement sensor, so that both materials and costs can be saved.

A “detachable connection” is in particular a connection that can be separated in a non-destructive manner by reversing the connection process. A detachable connection is in particular a screw connection by means of a thread or a plug connection.

A “supply line” is in particular a pipe for supplying the product to be dried (liquid) and/or the drying gas to the spray nozzle.

In another aspect of the invention, the problem is solved by a spray dryer for drying a product to be dried, wherein the spray dryer comprises at least one previously described spray nozzle or a measurement sensor for measuring a measured value disposed in the container, in particular in a groove, wherein the measurement sensor has an assigned autarkic energy supply and/or comprises an autarkic energy supply, in particular by means of a piezo-element, so that the measurement sensor can be operated without an external cable-based energy supply, so that the drying process of the product to be dried can be captured and measured and/or monitored by means of a measurement signal of the measurement sensor of the spray nozzle or in the container.

Thus, the formation of deposits and areas with increased temperatures can be captured and measured as well as monitored in a spray dryer directly at the spray nozzles as a place at which they tend to form. Consequently, the risk of fire and explosion can be reduced and a malfunction of a spray nozzle and/or of the entire spray dryer can be avoided and their service life can be increased.

In addition, a more homogeneous temperature distribution inside the drying chamber, and thus a higher quality of the drying product can be achieved due to the more precise capture, measurement, monitoring and/or adjustment of the drying process.

A “spray dryer” (also referred to as a drying tower) is in particular a device for drying solutions, suspensions or emulsions. In a spray dryer, a product to be dried is introduced, in particular by means of a spray nozzle, into a drying gas flow, which dries in a very short time (a few seconds to fractions of a second) so that it forms a fine powder. A spray dryer comprises in particular at least one spray nozzle, a supply for the drying gas and the product to be dried and a drying chamber.

A “container” is a chamber of the spray drier, in which the drying of the sprayed product occurs. The measurement sensor can be disposed for example on an inner wall of the container or on a fluid bed dryer.

In an additional aspect of the invention, the problem is solved by a method for monitoring and/or controlling and/or regulating a temperature during spraying of a product to be dried by means of a previously described spray nozzle or in a previously described spray dryer, including the following steps of:
spraying the product to be dried by means of the spray nozzle in a drying gas,
measuring the temperature by means of a measurement sensor of the spray nozzle during the drying process of the product to be dried,
monitoring and/or controlling and/or regulating the temperature during the drying process of the product to be dried.

Thus, a method can be provided that allows for a quick and locally more precise monitoring of potential flame sources during spraying of a product to be dried. Consequently, a more homogeneous temperature distribution during spray drying and thus higher quality dried particles can be achieved.

A “drying gas” is in particular air and/or an inert gas, such as e.g. nitrogen. The drying gas is guided through the spray dryer in particular as a gas flow, in order to dry the product to be dried. The drying gas has in particular a temperature between 100 and 350° C., preferably between 150 and 250° C. The drying gas is introduced against the current or with the current or in different places into the spray dryer.

In the following, the invention will be described in more detail based on exemplary embodiments. In the drawings:

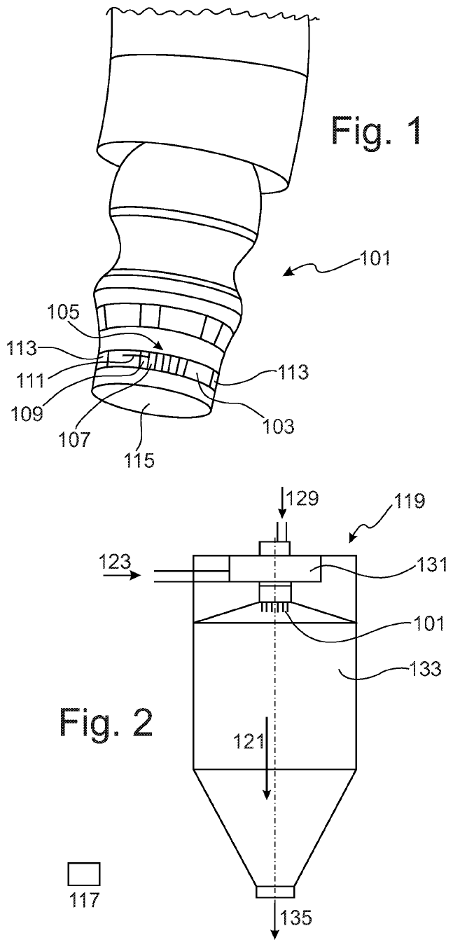

FIG. 1 shows a schematic perspective representation of a two-substance nozzle with a SAW-Sensor in an outside groove and

FIG. 2 shows a highly schematic sectional representation of a spray dryer with six two-substance nozzles.

A two-substance nozzle 101 comprises a nozzle opening 115 at its lower end. A radially circumferential groove 103 is placed in the outer casing of the two-substance nozzle 101 at a distance of 10 mm from the nozzle opening 115. A SAW-sensor 105 is disposed in the groove 103. The SAW-sensor 105 comprises a piezo-electric substrate 107, an emitter 109 and an antenna 111.

The piezoelectric substrate 107 is clamped in the groove 103 in a dimension of the groove 103 oriented in the longitudinal direction of the two-substance nozzle 101. In contrast, the width of the SAW-sensor 105 and of the piezoelectric substrate 107 in the radial direction is smaller than the dimension of the circumferential groove 103.

The SAW-sensor 105 measures 5×3 mm² and weighs 2 g. The SAW-sensor 105 is embedded together with its antenna 111 in the groove 103 by means of a quartz glass 113, so that the groove 103 is completely filled with the quartz glass 113.

At its head, a spray dryer 119 comprises a hot-air supply 123, a milk supply 129, an air distributor 131 and six two-substance nozzles 101. The drying chamber 133 is disposed below the six two-substance nozzles 101 and a milk powder and air outlet is located at the bottom end of the spray dryer 119. An external receiver 117 is disposed at a 15 m distance from the spray dryer 119.

The following work steps are carried out by the spray nozzles 101 in the spray dryer 119:

Previously partly dehydrated milk is supplied by way of the milk supply 129 and hot air with a temperature of 180° C. is supplied by way of the hot-air supply 123 and the air distributor 131 to the six two-substance nozzles 101 in the spray dryer 119. The previously partly dehydrated milk is sprayed in fine droplets by means of the six two-substance nozzles 101 and dried by the hot air introduced with the current. In doing so, the sprayed droplets fall with the current through the hot air flow 121, thus forming, within one second, milk powder, which is heated to a temperature of 60° C. The dried milk power is discharged at the foot of the spray dryer 119 by way of the milk powder and air outlet 135. The milk powder is then separated from the air flow by way of a centrifugal separator not shown.

During spraying of the previously partly dehydrated milk, the SAW-sensors 105, which are respectively disposed at the six two-substance nozzles 101, measure the respective temperatures. Since the piezoelectric substrates 107 are respectively clamped between the two opposite walls of the respective groove 105 in the longitudinal direction of the two-substance nozzle 101, the piezoelectric substrates 107 respectively generate an electric voltage, which serves to continuously or discontinuously supply the respective SAW-sensors 105 with an electric voltage.

The SAW-sensors 105 send their temperature measurement signals respectively by means of their emitter 109 and their antenna 111 to the external receiver 117. In doing so, the SAW-sensors 105 emit at different frequencies in a range of frequencies of 2,400 MHZ to 2,483 MHz. Thus, the external receiver 117 can unambiguously identify the six two-substance nozzles 101 and unambiguously attribute the transmitted temperature signals to the individual two-substance nozzles 101. The external receiver 117 monitors the temperature signals of the six two-substance nozzles 101 during drying of the previously partly dehydrated milk powder.

The receiver 117 detects an increased temperature at one of the six two-substance nozzles 101 and causes a reduction of the hot-air flow through this two-substance nozzle 101 by way of a programmable logic controller. Since the subsequent measurements at this two-substance nozzle 101 continue to show an excessively high temperature, this two-substance nozzle 101 is automatically shut down, in order to prevent a possible inflammation of deposited milk powder at this two-substance nozzle 101.

Thus, a two-substance nozzle and a spray dryer are provided, which ensure a homogeneous temperature distribution in the drying chamber during spraying of previously partly dehydrated milk and thus reduce the risk of fire and explosion. At the same time, the homogeneous temperature distribution at all the two-substance nozzles allows for the production of a high-quality and uniformly dried milk powder.

### LIST OF REFERENCE NUMERALS

101 Two-substance nozzle
103 Groove
105 SAW-sensor
107 Piezoelectric substrate
109 Sender
111 Emitter
113 Quartz glass
115 Nozzle opening
117 External receiver
119 Spray dryer
121 Hot-air flow
123 Hot-air supply
129 Milk supply
131 Air distributor
133 Drying chamber
135 Milk powder and air outlet

1. A spray nozzle for spraying a product to be dried, wherein the spray nozzle comprises:
a groove on an outer wall,
wherein a measurement sensor for measuring a measured value is disposed in the groove,
and wherein an autarkic energy supply is associated with the measurement sensor and/or the autarkic energy supply is disposed in the groove, so that the measurement sensor can be operated without an external cable-based energy supply.

2. The spray nozzle according to claim 1, wherein the measurement sensor comprises:
an emitter and
an antenna for wireless transmission of a measurement signal.

3. The spray nozzle according to claim 2, wherein the measurement sensor and/or the antenna is embedded in the groove by a casting material.

4. The spray nozzle according to claim 2, wherein an external receiver for reading, evaluating and/or monitoring the measurement signal is assigned to the spray nozzle.

5. The spray nozzle according to claim 2, wherein the emitter has a frequency in the range of 9 kHz to 300 GHz.

6. The spray nozzle according to claim 2, wherein a piece of information for identifying the spray nozzle can be sent by the emitter.

7. The spray nozzle according to claim 1, wherein the measurement sensor is a temperature sensor and/or a pressure sensor.

8. The spray nozzle according to claim 1, wherein the spray nozzle is connected with a supply line by a detachable connection.

9. A spray dryer for drying a product to be dried, characterized by
at least one spray nozzle according to claim 1,
a measurement sensor for measuring a measured value disposed in the container, wherein the measurement sensor has an assigned autarkic energy supply,. and/or
an autarkic energy supply so that the measurement sensor can be operated without an external cable-based energy supply, so that a drying process of the product to be dried can be captured and measured and/or monitored as of a measurement signal of the measurement sensor of the spray nozzle or in the container.

10. A method for monitoring,. and/or controlling,. and/or regulating a temperature when spraying of a product to be dried by the spray nozzle according to claim 1, the method comprising:
spraying the product to be dried by the spray nozzle in a drying gas,
measuring the temperature by a measurement sensor of the spray nozzle during the drying process of the product to be dried,
monitoring, and/or controlling, and/or regulating the temperature during the drying process of the product to be dried.

11. The spray nozzle according to claim 1, wherein the autarkic energy supply is a piezo element.

12. The spray nozzle according to claim 5, wherein the emitter has a frequency in the range of 400 MHz to 2.5 GHz.

13. A method for monitoring, and/or controlling, and/or regulating a temperature when spraying of a product to be dried in the spray dryer according to claim 9, the method comprising:
spraying a product to be dried by the spray nozzle in a drying gas,
measuring the temperature by a measurement sensor of the spray nozzle during the drying process of the product to be dried, and
monitoring, and/or controlling, and/or regulating the temperature during the drying process of the product to be dried.

14. The spray dryer according to claim 9, wherein the measurement sensor is disposed in a groove on an outer wall of the spray nozzle.

15. The spray dryer according to claim 9, wherein the autarkic energy supply is a piezo element.
